(19) United States
(12) Patent Application Publication
(10) Pub. No.: US 2023/0039407 A1
(43) Pub. Date: Feb. 9, 2023

(54) COMMUNICATION DEVICE AND SYSTEM

(71) Applicant: KABUSHIKI KAISHA TOKAI RIKA DENKI SEISAKUSHO, Aichi (JP)

(72) Inventors: Masateru FURUTA, Aichi (JP); Shigenori NITTA, Aichi (JP); Yuki KONO, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 17/766,470

(22) PCT Filed: Aug. 7, 2020
(86) PCT No.: PCT/JP2020/030426

§ 371 Date: Apr. 4, 2022

(30) Foreign Application Priority Data
Dec. 26, 2019 (JP) 2019-236755

(51) Int. Cl. H04L 5/00; B60R 25/24; H04W 64/00; H04W 12/06

(52) U.S. Cl. CPC H04L 5/0048; B60R 25/24; H04W 64/00; H04W 12/06; H04L 5/0055; E05B 49/00

(57) ABSTRACT

A communication device includes: a control unit configured to control a process of transmitting a first ranging signal, receiving a second ranging signal transmitted as a response to the first ranging signal from another communication device receiving the first ranging signal, and transmitting a data signal including regulation information regarding a transmission time of the first ranging signal and a reception time of the second ranging signal, wherein the data signal is transmitted and received in conformity with a first wireless communication standard, and wherein the first and second ranging signals are transmitted and received in conformity with a second wireless communication standard more appropriate for ranging than the first wireless communication standard.

### TECHNICAL FIELD

The present invention relates to a communication device and a system.

### BACKGROUND ART

In recent years, various technologies for measuring distances between devices (hereinafter referred to as ranging) have been developed. For example, Patent Literature 1 discloses a technology for measuring a distance between devices based on a period from transmission of a signal to reception of a response to the signal.

### CITATION LIST

### Patent Literature

Patent Literature 1: JP H11-208419A

### SUMMARY OF INVENTION

### Technical Problem

Standards appropriate for wireless communication are considered to differ in accordance with the nature of transmitted and received signals. In Patent Literature 1, however, a wireless communication standard used to transmit and receive a signal was not examined

Accordingly, the present invention has been devised in view of the foregoing problem and an objective of the present invention is to provide a structure for suitably using a wireless communication standard appropriate for transmitting and receiving a signal related to ranging between devices.

### Solution to Problem

To solve the above described problem, according to an aspect of the present invention, there is provided a communication device comprising: a control unit configured to control a process of transmitting a first ranging signal, receiving a second ranging signal transmitted as a response to the first ranging signal from another communication device receiving the first ranging signal, and transmitting a data signal including regulation information regarding a transmission time of the first ranging signal and a reception time of the second ranging signal, wherein the data signal is transmitted and received in conformity with a first wireless communication standard, and wherein the first and second ranging signals are transmitted and received in conformity with a second wireless communication standard more appropriate for ranging than the first wireless communication standard.

To solve the above described problem, according to another aspect of the present invention, there is provided a communication device comprising: a control unit configured to control a process of receiving a first ranging signal from another communication device, transmitting a second ranging signal as a response to the first ranging signal, and receiving a data signal including information regarding a transmission time of the first ranging signal and a reception time of the second ranging signal in the other communication device from the other communication device, wherein the data signal is transmitted and received in conformity with a first wireless communication standard, and wherein the first and second ranging signals are transmitted and received in conformity with a second wireless communication standard more appropriate for ranging than the first wireless communication standard.

To solve the above described problem, according to another aspect of the present invention, there is provided a system comprising: a first communication device; and a second communication device, wherein the first communication device includes a first control unit that controls a process of transmitting a first ranging signal, receiving a second ranging signal transmitted as a response to the first ranging signal from the second communication device receiving the first ranging signal, and transmitting a data signal including information regarding a transmission time of the first ranging signal and a reception time of the second ranging signal, wherein the second communication device includes a second control unit that controls a process of receiving the first ranging signal from the first communication device, transmitting the second ranging signal, and receiving the data signal from the first communication device, wherein the data signal is transmitted and received in conformity with a first wireless communication standard, and wherein the first and second ranging signals are transmitted and received in conformity with a second wireless communication standard more appropriate for ranging than the first wireless communication standard.

### Advantageous Effects of Invention

As described above, the present invention provides a structure for suitably using a wireless communication standard appropriate for transmitting and receiving a signal related to ranging between devices.

### BRIEF DESCRIPTION OF DRAWINGS

FIG. 1 is a diagram illustrating an exemplary configuration of a system according to an embodiment of the present invention.

FIG. 2 is a sequence diagram illustrating an example of a flow of a typical ranging process.

FIG. 3 is a sequence diagram illustrating an example of a flow of an authentication process performed by the system according to the embodiment.

### DESCRIPTION OF EMBODIMENTS

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### <1. Exemplary Configuration>

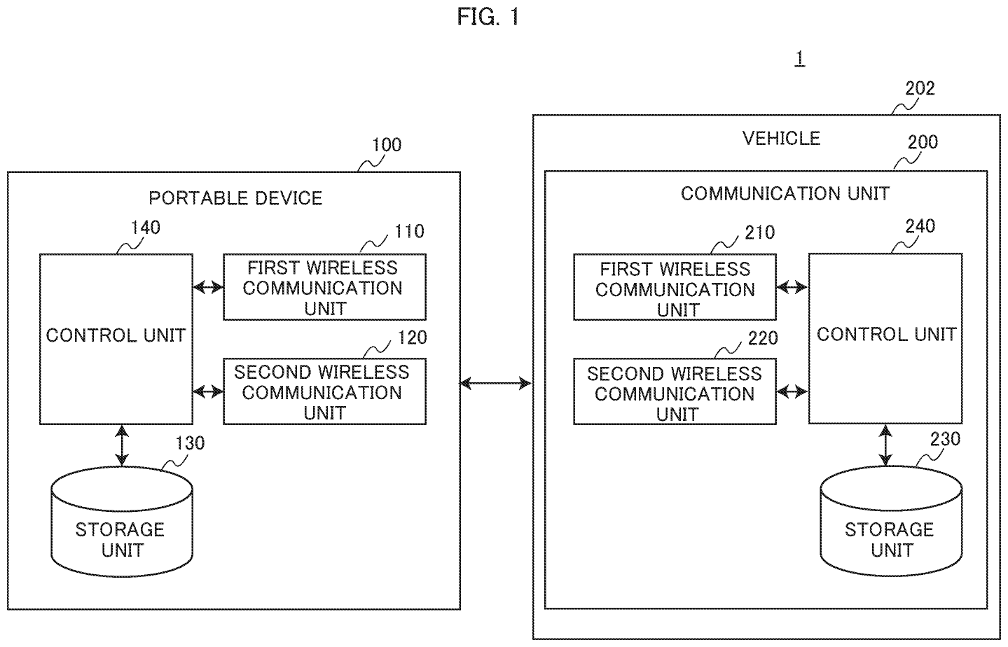

FIG. 1 is a diagram illustrating an exemplary configuration of a system 1 according to an embodiment of the present invention. As illustrated in FIG. 1, the system 1 according to the embodiment includes a portable device 100 and a communication unit 200. In the embodiment, the communication unit 200 is mounted in a vehicle 202. The vehicle 202 is an example of an object used by a user.

In the present invention, a communication device to be authenticated (also referred to as a first communication device) and a communication device performing authentication (also referred to as a second communication device) are involved. In the example illustrated in FIG. 1, the portable device 100 is an example of the first communication device and a communication unit mounted in the vehicle 202 is an example of the second communication device.

In the system 1, when a user (for example, a driver of the vehicle 202) carrying a portable device 100 approaches the vehicle 202, wireless communication for authentication is performed between the portable device 100 and the communication unit 200 of the vehicle 202. When the authentication is successful, a door lock of the vehicle 202 is unlocked or an engine is started and the vehicle 202 enters a state in which the vehicle 202 can be used by the user. The system 1 is also referred to as a smart entry system. Hereinafter, each constituent will be described in order.

### (1) Portable Device 100

The portable device 100 is configured as any device carried and used by the user. Examples of any device include an electronic key, a smartphone, and a wearable terminal. As illustrated in FIG. 1, the portable device 100 includes a first wireless communication unit 110, a second wireless communication unit 120, a storage unit 130, and a control unit 140.

The first wireless communication unit 110 has a function of performing communication with the communication unit 200 of the vehicle 202 in conformity with a first wireless communication standard. The second wireless communication unit 120 has a function of performing communication with the communication unit 200 of the vehicle 202 in conformity with a second wireless communication standard. In particular, the second wireless communication standard is more appropriate for ranging than the first wireless communication standard. The second wireless communication unit 120 is mainly in charge of communication for ranging.

Here, the first wireless communication standard may satisfy at least one of the conditions that a gain is higher and power consumption of a reception side is lower than in the second wireless communication standard.

As a specific example in which such requisites are satisfied, in the second wireless communication standard, a carrier wave with a frequency higher than a frequency of a carrier wave in the first wireless communication standard may be used. This is because attenuation in accordance with a distance increases with an increase in the frequency of the carrier wave, a gain therefore decreases, attenuation in accordance with a distance decreases with a decrease in the frequency of the carrier wave, a gain therefore increases, and thus the requisites for the gain are satisfied.

When the frequency of the carrier wave increases, the influence on the human body such as absorption thereby increases, and thus a gain decreases.

In consideration that a sampling frequency is set in accordance with a maximum value of a frequency of a carrier wave, it should be satisfied that at least a maximum frequency of the carrier wave in the second wireless communication standard is higher than a maximum frequency of the carrier wave in the first wireless communication standard.

For example, in the first wireless communication standard, a signal with an ultra-high frequency (UHF) band and a signal with a low frequency (LF) band may be used. In a typical smart entry system, the signal with an UHF band is used for transmission from the portable device 100 to the communication unit 200 of the vehicle 202 and the signal with an LF band is used for transmission from the communication unit 200 of the vehicle 202 to the portable device 100. Hereinafter, it is assumed that the first wireless communication unit 110 is configured as a communication interface capable of performing communication with a signal with the UHF band and a signal with the LF band in description. That is, hereinafter, it is assumed that a signal with the UHF band is used for transmission to the communication unit 200 of the vehicle 202 and a signal with the LF band is used for reception from the communication unit 200 of the vehicle 202.

For example, in the second wireless communication standard, a signal with an ultra-wide band (UWB) may be used. A signal of an impulse scheme of the UWB has a feature in which positioning and ranging can be performed with high accuracy. That is, by using a radio wave with a very short pulse width equal to or less than nanoseconds, it is possible to measure an aerial propagation time of a radio wave with high accuracy and perform positioning and ranging based on the propagation time with high accuracy. Hereinafter, it is assumed that the second wireless communication unit 120 is configured as a communication interface capable of performing communication in a signal with an UWB.

A signal with the UWB can be transmitted and received as a ranging signal and a data signal. The ranging signal is a signal transmitted and received in a ranging process to be described below. The ranging signal may have a frame format that has no payload in which data is stored or may have a frame format that has a payload. The data signal is a signal for conveying data. The data signal preferably has a frame format that has a payload in which data is stored. Hereinafter, it is assumed that the ranging signal has a frame format that has no payload in which data is stored. It is also assumed that the data signal has a frame format that has a payload in which data is stored.

The storage unit 130 has a function of storing various kinds of information for an operation of the portable device 100. For example, the storage unit 130 stores a program for an operation of the portable device 100, an identifier (ID), a password, and an authentication algorithm for authentication. The storage unit 130 is configured with, for example, a storage medium such as a flash memory and a processing device that performs recording and reproducing on the storage medium.

The control unit 140 has a function of controlling a general operation in the portable device 100. For example, the control unit 140 controls the first wireless communication unit 110 and the second wireless communication unit 120 and communicates with the communication unit 200 of the vehicle 202. The control unit 140 reads information from the storage unit 130 and writes information on the storage unit 130. The control unit 140 functions as an authentication control unit that controls an authentication process performed with the communication unit 200 of the vehicle 202. The control unit 140 is configured with, for example, an electronic circuit such as a central processing unit (CPU) and a microprocessor.

### (2) Communication Unit 200

The communication unit 200 is provided in association with the vehicle 202. Here, the communication unit 200 is mounted in the vehicle 202 in such a manner that, for example, the communication unit 200 is provided in the interior of the vehicle 202 or is embedded as a communication module in the vehicle 202. As illustrated in FIG. 1, the communication unit 200 includes a first wireless communication unit 210, a second wireless communication unit 220, a storage unit 230, and a control unit 240.

The first wireless communication unit 210 has a function of performing communication in conformity with the first wireless communication standard with the portable device 100. Hereinafter, it is assumed that the first wireless communication unit 210 is configured as a communication interface capable of performing communication in a signal with the UHF band and a signal with the LF band.

The second wireless communication unit 220 has a function of performing communication in conformity with the second wireless communication standard with the portable device 100. Hereinafter, it is assumed that the second wireless communication unit 220 is configured as a communication interface capable of performing communication in a signal with the UWB.

The storage unit 230 has a function of storing various kinds of information for an operation of the communication unit 200. For example, the storage unit 230 stores a program for an operation of the communication unit 200 and an authentication algorithm or the like. The storage unit 230 is configured with, for example, a storage medium such as a flash memory and a processing device that performs recording and reproducing on the storage medium.

The control unit 240 has a function of controlling general operations of the communication unit 200 and in-vehicle devices mounted in the vehicle 202. For example, the control unit 240 controls the first wireless communication unit 210 and the second wireless communication unit 220 and communicates with the portable device 100. The control unit 240 reads information from the storage unit 230 and writes information on the storage unit 230. The control unit 240 functions as an authentication control unit that controls an authentication process performed with the portable device 100. The control unit 240 also functions as a door lock control unit that controls a door lock of the vehicle 202 and performs locking and unlocking of the door lock. The control unit 240 also functions as an engine control unit that controls an engine of the vehicle 202 and performs starting/stopping of the engine. A driving source with which the vehicle 202 is equipped may be a motor or the like other than an engine. The control unit 240 is configured as, for example, an electronic control unit (ECU).

### <2. Technical Problem>

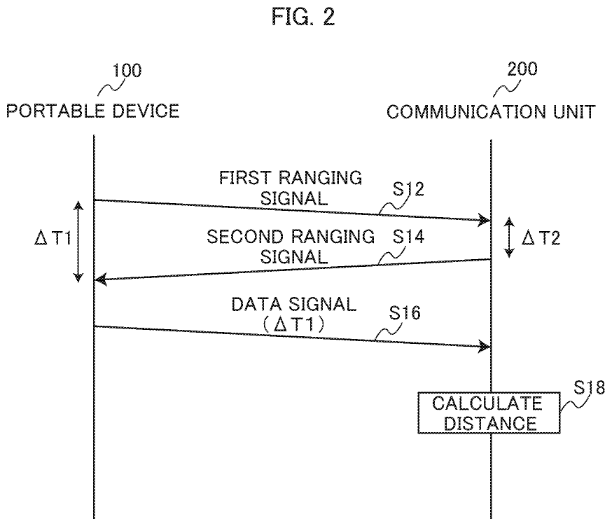

In a smart entry system, authentication of the portable device 100 is performed based on a distance between the portable device 100 and the communication unit 200 of the vehicle 202 in some cases. An example of a typical flow of a ranging process performed at that time will be described with reference to FIG. 2.

FIG. 2 is a sequence diagram illustrating an example of a flow of a typical ranging process. In the sequence, the portable device 100 and the communication unit 200 of the vehicle 202 are involved. As illustrated in FIG. 2, the portable device 100 first transmits a first ranging signal (step S12). When the first ranging signal is received from the portable device 100, the communication unit 200 transmits a second ranging signal as a response to the first ranging signal (step S14). When the second ranging signal is received, the portable device 100 measures a time ΔT1 from a transmission time of the first ranging signal to a reception time of the second ranging signal. Subsequently, the portable device 100 transmits a data signal including information obtained by encrypting information indicating the measured time ΔT1 (step S16). On the other hand, the communication unit 200 measures a time ΔT2 from a reception time of the first ranging signal to a transmission time of the second ranging signal. Then, when the data signal is received from the portable device 100, the communication unit 200 calculates a distance between the portable device 100 and the communication unit 200 based on the time ΔT1 indicated by the data signal received from the portable device 100 and the measured time ΔT2 (step S18). For example, a time taken to transmit and receive a one-way signal is calculated by dividing ΔT1−ΔT2 by 2, and the distance between the portable device 100 and the communication unit 200 is calculated by multiplying the time by a speed of the signal.

Here, a ranging process is a process of measuring a distance between the portable device 100 and the communication unit 200. A ranging signal is a signal transmitted and received to measure a distance between the portable device 100 and the communication unit 200 in wireless communication between the portable device 100 and the communication unit 200.

In the sequence illustrated in FIG. 2, the ranging process can be started when the portable device 100 transmits a ranging signal. Therefore, reception of the ranging signal by the portable device 100 does not need to be awaited, and thus power consumption of the portable device 100 can be reduced to that extent. In the sequence illustrated in FIG. 2, the communication unit 200 which is an authentication entity calculates the distance. Therefore, the authentication based on the distance can be performed efficiently.

Here, in a typical smart entry system, the data signal in step S16 is included and the UWB is used to transmit and receive the signals illustrated in FIG. 2. Since the data signal with the UWB has a frame length longer than the ranging signal that has a payload, reception sensitivity is worse than that of the ranging signal. Therefore, there is room for improving total reception sensitivity of the ranging process of transmitting the data signal at the UWB. Further, since power consumption of a reception side is large for the UWB, a battery voltage may decrease rapidly.

Accordingly, in an embodiment of the present invention, a wireless communication standard appropriate to transmit and receive signals for ranging between devices is suitably used. Specifically, a wireless communication standard used for a ranging signal and a data signal is suitably used. Thus, it is possible to improve total reception sensitivity and reduce power consumption. Hereinafter, technical features of the embodiment of the present invention will be described.

### <3. Technical Features>

### (1) 2-Step Authentication

The portable device 100 and the communication unit 200 of the vehicle 202 according to the embodiment perform a plurality of authentication processes step by step. For example, two-step authentication is assumed to be performed here.

An authentication process of the first step (hereinafter also referred to as a first authentication process) includes, for example, a request response authentication. The request response authentication is an authentication scheme in which an authentication party generates an authentication request and transmits the authentication request to a party to be authenticated, the party to be authenticated generates an authentication response based on the authentication request and transmits the authentication response to the authentication party, and the authentication party authenticates the party to be authenticated based on the authentication response. The authentication request is data. The authentication response is data generated based on the authentication request and information regarding the party to be authenticated (for example, an ID and a password). Typically, since the authentication request is a random number and is changed at each authentication, request response authentication has a resistant to a replay attack. The authentication response is generated based on the information regarding the party to be authenticated (for example, an ID and a password), that is, the ID and the password themselves are not transmitted and received. Therefore, wiretapping is prevented.

An authentication process of the second stage (hereinafter also referred to as a second authentication process) performed after the first authentication process is, for example, authentication based on a distance. The authentication based on a distance includes a process of measuring a distance between the portable device 100 and the communication unit 200 and a process of performing authentication based on a distance measurement result. The ranging process of the former will be described in detail below. In the authentication of the latter, the communication unit 200 of the vehicle 202 authenticates the portable device 100 depending on whether a measured distance satisfies a predetermined condition. For example, when the measured distance is equal to or less than a predetermined value, the communication unit 200 of the vehicle 202 determines that the authentication is successful. Otherwise, the communication unit 200 of the vehicle 202 determines that the authentication fails. By performing the authentication based on the distance in addition to the request response authentication, it is possible to further enhance security.

Prior to the first authentication process, a wake-up signal for giving an instruction for starting and a response to the wake-up signal may be transmitted and received. The wake-up signal enables a reception side to return from a sleep state. As the response to the wake-up signal, a positive response (acknowledgement (ACK)) signal indicating starting and a negative response (negative acknowledgement (NACK)) signal indicating non-starting can be exemplified.

### (2) Ranging Process

The portable device 100 and the communication unit 200 according to the embodiment performs a ranging process of measuring a distance between the portable device 100 and the communication unit 200 to perform authentication based on a distance. At this time, the portable device 100 and the communication unit 200 perform the ranging process described above with reference to FIG. 2 while suitably using a wireless communication standard appropriate to transmit and receive signals.

Specifically, the portable device 100 transmits the first ranging signal, receives the second ranging signal transmitted as a response to the first ranging signal from the communication unit 200 receiving the first ranging signal, and transmits the data signal. The communication unit 200 receives the first ranging signal from the portable device 100, transmits the second ranging signal as the response to the first ranging signal, and receives the data signal from the portable device 100 receiving the second ranging signal. In the embodiment, the first and second ranging signals are transmitted as signals with the UWB. Thus, high ranging accuracy is implemented with the UWB. Since the ranging signal has no payload, deterioration in sensitivity can be prevented. On the other hand, the data signal is transmitted as a signal with the UHF/LF band. Since a signal with the UHF/LF band is used to transmit the data signal, deterioration in total reception sensitivity can be prevented and power consumption of the reception side can be reduced compared to the case in which a signal with the UWB is used to transmit the data signal. In this way, through the ranging process according to the embodiment, it is possible to keep high ranging accuracy with the UWB, prevent the deterioration in the total reception sensitivity, and reduce the total power consumption.

The communication unit 200 calculates a distance between the portable device 100 and the communication unit 200 based on the data signal received from the portable device 100. The data signal includes information indicating the time ΔT1 from a transmission time of the first ranging signal to a reception time of the second ranging signal in the portable device 100. The communication unit 200 measures the time ΔT2 from a reception time of the first ranging signal to a transmission time of the second ranging signal and calculates a distance between the portable device 100 and the communication unit 200 based on the time ΔT1 indicated by the data signal and the measured time ΔT2. Specifically, a time taken to transmit and receive a one-way signal is calculated by dividing a value obtained by subtracting ΔT2 from ΔT1 by 2, and the distance between the portable device 100 and the communication unit 200 is calculated by multiplying the time by a speed of the signal.

The transmission times and the reception times of the ranging signals may be absolute times. Besides, the transmission times and the reception times of the ranging signals may be relative times determined by using a predetermined timing (for example, a starting time) as a reference.

### (3) Flow of Process

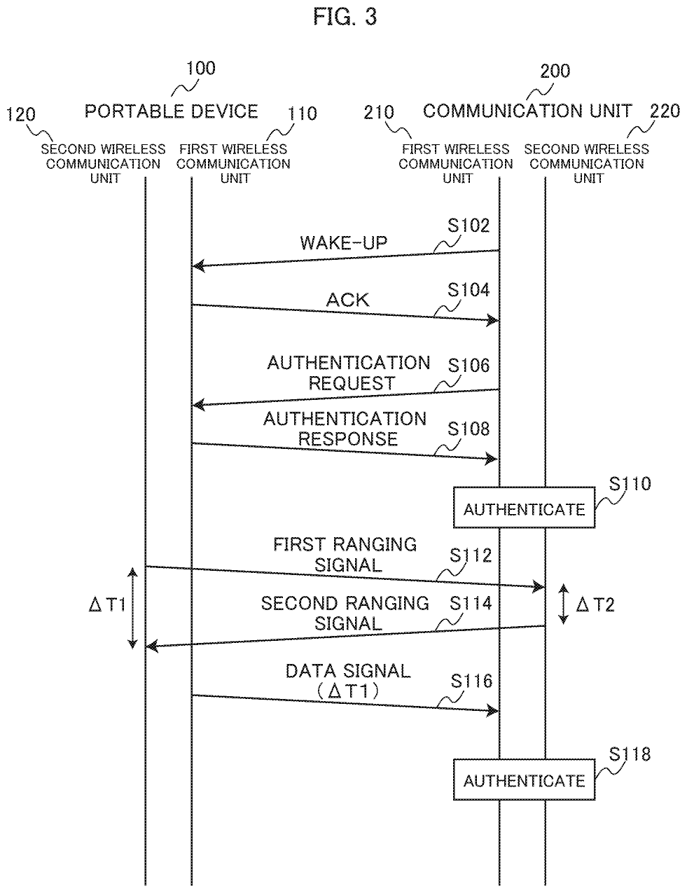

FIG. 3 is a sequence diagram illustrating an example of a flow of an authentication process performed by the system 1 according to the embodiment. In the sequence, the portable device 100 and the communication unit 200 are involved.

As illustrated in FIG. 3, the first wireless communication unit 210 of the communication unit 200 first transmits a wake-up signal for giving an instruction to start the portable device 100 (step S102). The wake-up signal may be transmitted as a signal with the UHF/LF band.

When the wake-up signal is received, the first wireless communication unit 110 of the portable device 100 transmits an ACK signal as a response to the wake-up signal (step S104). The ACK signal may be transmitted as a signal with the UHF/LF band.

Subsequently, the request response authentication is performed as the first authentication process.

First, the control unit 240 generates an authentication request. Then, the first wireless communication unit 210 transmits a signal including the generated authentication request (step S106). The signal including the authentication request may be transmitted as a signal with the UHF/LF band.

When the first wireless communication unit 110 receives the signal including the authentication request, the control unit 140 of the portable device 100 generates an authentication response based on the received authentication request. Then, the first wireless communication unit 110 transmits the signal including the generated authentication response (step S108). The signal including the authentication response may be transmitted as a signal with the UHF/LF band.

When the first wireless communication unit 210 receives the signal including the authentication response, the control unit 240 of the communication unit 200 authenticates the portable device 100 based on the received authentication response (step S110).

Subsequently, authentication based on a distance is performed as the second authentication process.

The second wireless communication unit 120 of the portable device 100 transmits the first ranging signal (step S112). The first ranging signal is transmitted as a signal with the UWB.

When the first ranging signal is received from the portable device 100, the second wireless communication unit 220 of the communication unit 200 transmits the second ranging signal as a response to the first ranging signal (step S114). The second ranging signal is transmitted as a signal with the UWB.

When the second wireless communication unit 120 receives the second ranging signal, the control unit 140 of the portable device 100 measures the time ΔT1 from the transmission time of the first ranging signal to the reception time of the second ranging signal. Subsequently, the first wireless communication unit 110 of the portable device 100 transmits the data signal including information obtained by encrypting information indicating the measured time ΔT1 (step S116). The data signal is transmitted as a signal with the UHF/LF band.

On the other hand, the control unit 240 of the communication unit 200 measures the time ΔT2 from the reception time of the first ranging signal to the transmission time of the second ranging signal. When the first wireless communication unit 210 receives the data signal from the portable device 100, the control unit 240 of the communication unit 200 calculates a distance between the portable device 100 and the communication unit 200 based on the time ΔT1 indicated by the received data signal and the measured time ΔT2. Thereafter, the control unit 240 performs authentication depending on whether the calculated distance satisfies the predetermined condition (step S118).

### <4. Supplements>

The preferred embodiments of the present invention have been described above with reference to the appended drawings, but the present invention is not limited to these examples. It should be apparent to those skilled in the technical field of the present invention that various modifications and corrections can be made in various forms within the scope of the technical spirit described in the claims, and the modifications and the corrections, of course, belong to the technical scope of the present invention.

For example, as described in the foregoing embodiment, the information indicating the time ΔT1 from the transmission time of the first ranging signal to the reception time of the second ranging signal in the portable device 100 is included in the data signal, but the present invention is not limited to this example. The data signal may include regulation information regarding a transmission time of the first ranging signal and a reception time of the second ranging signal. Hereinafter, another example of the regulation information included in the data signal will be described.

As another example of the regulation information included in the data signal, information indicating a distance between the portable device 100 and the communication unit 200 calculated based on a time from a transmission time of the first ranging signal to a reception time of the second ranging signal can be exemplified. That is, instead of the communication unit 200, the portable device 100 may calculate a distance between the portable device 100 and the communication unit 200 based on ΔT1 and ΔT2 and transmit information indicating the calculated distance. To do this, for example, it is preferable that ΔT2 be a fixed value and be shared between the portable device 100 and the communication unit 200. Thus, the portable device 100 can calculate the distance based on the measured time ΔT1 and the existing time ΔT2. In this example, it is possible to reduce a processing load on the communication unit 200. Further, as still another example of the regulation information included in the data signal, information indicating a result of authentication between the portable device 100 and the communication unit 200 based on the distance between the portable device 100 and the communication unit 200 calculated in the foregoing way can be exemplified. That is, instead of the communication unit 200, the portable device 100 may calculate the distance between the portable device 100 and the communication unit 200 based on ΔT1 and ΔT2, perform authentication based on the calculated distance, and transmit information indicating a result of authentication. In this example, it is possible to further reduce a processing load on the communication unit 200.

As still another example of the regulation information included in the data signal, information indicating a transmission time of the first ranging signal and a reception time of the second ranging signal in the portable device 100 can be exemplified. That is, the portable device 100 may transmit start and end time stamps of ΔT1 without calculating ΔT1. In this case, it is possible to reduce the processing load on the portable device 100 and shorten a response time.

Besides, for example, as described in the foregoing embodiment, the party to be authenticated is the portable device 100 and the authentication party is the communication unit 200, but the present invention is not limited to this example. The roles of the portable device 100 and the communication unit 200 may be reversed or the roles thereof may be dynamically exchanged. The ranging and the authentication may be performed between the communication units 200.

Besides, for example, as described in the foregoing embodiment, the example in which the present invention is applied to the smart entry system has been described, but the present invention is not limited to this example. The present invention can be applied to any system that performs ranging and authentication by transmitting and receiving signals. For example, the present invention can be applied to a pair of any two devices among a portable device, a vehicle, a smartphone, a drone, a home, and a home appliance. In this case, one of the pair of devices operates an authentication party and the other operates an authentication party. The pair of devices may include the same types of two devices or may include different types of two devices.

Besides, for example, as described in the foregoing embodiment, the UHF/LF is used as the first wireless communication standard and the UWB is used as the second wireless communication standard, but the present invention is not limited to this example. For example, Wi-Fi (registered trademark) and Bluetooth (registered trademark) may be used as the first wireless communication standard. For example, a wireless communication standard using an infrared ray may be used as the second wireless communication standard.

Besides, for example, as described in the foregoing embodiment, the authentication based on the authentication response, the calculation of the distance based on ΔT1 and ΔT2, and the authentication based on the distance are performed by the communication unit 200, but the present invention is not limited to this example.

Besides, for example, as described in the foregoing embodiment, the control unit 240 is configured as the ECU and controls the general operation of the communication unit 200, but the present invention is not limited to this example. For example, the first wireless communication unit 210 may include an ECU. The first wireless communication unit 210 may perform at least part of information processing such as generation of an authentication request related to the communication by the first wireless communication unit 210. The same applies to the second wireless communication unit 220.

Besides, for example, as described above, the communication unit 200 is mounted in the vehicle 202, but the present invention is not limited to this example. For example, a part or the entirety of the communication unit 200 may be configured separately from the vehicle 202 in such a manner that the communication unit 200 is provided in a parking lot of the vehicle 202. In this case, the communication unit 200 can remotely control the vehicle 202 by wirelessly transmitting a control signal to the vehicle 202 based on a result of communication with the portable device 100.

Note that, a series of processes performed by the devices described in this specification may be achieved by any of software, hardware, and a combination of software and hardware. A program that configures software is stored in advance in, for example, a recording medium (non-transitory medium) installed inside or outside the devices. In addition, for example, when a computer executes the programs, the programs are read into random access memory (RAM), and executed by a processor such as a CPU. The recording medium may be a magnetic disk, an optical disc, a magneto-optical disc, flash memory, or the like. Alternatively, the above-described computer program may be distributed via a network without using the recording medium, for example.

Further, in the present specification, the processes described using the flowcharts and the sequence diagrams are not necessarily executed in the order illustrated in the drawings. Some processing steps may be executed in parallel. In addition, additional processing steps may be employed and some processing steps may be omitted.

### REFERENCE SIGNS LIST

1 system
100 portable device
110 first wireless communication unit
120 second wireless communication unit
130 storage unit
140 control unit
200 communication unit
202 vehicle
210 first wireless communication unit
220 second wireless communication unit
230 storage unit
240 control unit

1. A communication device comprising:
a control unit configured to control a process of transmitting a first ranging signal, receiving a second ranging signal transmitted as a response to the first ranging signal from another communication device receiving the first ranging signal, and transmitting a data signal including regulation information regarding a transmission time of the first ranging signal and a reception time of the second ranging signal,
wherein the data signal is transmitted and received in conformity with a first wireless communication standard, and
wherein the first and second ranging signals are transmitted and received in conformity with a second wireless communication standard more appropriate for ranging than the first wireless communication standard.

2. The communication device according to claim 1, wherein the data signal includes information indicating a time from the transmission time of the first ranging signal to the reception time of the second ranging signal as the regulation information.

3. The communication device according to claim 1, wherein the data signal includes information indicating a distance between the communication device and the other communication device calculated based on a time from the transmission time of the first ranging signal to the reception time of the second ranging signal as the regulation information.

4. The communication device according to claim 1, wherein the data signal includes information indicating a result of authentication between the communication device and the other communication device based on a distance between the communication device and the other communication device calculated based on a time from the transmission time of the first ranging signal to the reception time of the second ranging signal as the regulation information.

5. The communication device according to claim 1, wherein the data signal includes information indicating the transmission time of the first ranging signal and the reception time of the second ranging signal as the regulation information.

6. The communication device according to claim 1, wherein the first wireless communication standard satisfies at least one of conditions that a gain is higher and power consumption of a reception side is lower than in the second wireless communication standard.

7. The communication device according to claim 6, wherein, in the second wireless communication standard, a carrier wave with a frequency higher than a frequency of a carrier wave in the first wireless communication standard is used.

8. The communication device according to claim 1,
wherein the other communication device is mounted in a vehicle, and
wherein the communication device is a device carried and used by a user of the vehicle.

9. A communication device comprising:
a control unit configured to control a process of receiving a first ranging signal from another communication device, transmitting a second ranging signal as a response to the first ranging signal, and receiving a data signal including information regarding a transmission time of the first ranging signal and a reception time of the second ranging signal in the other communication device from the other communication device,
wherein the data signal is transmitted and received in conformity with a first wireless communication standard, and
wherein the first and second ranging signals are transmitted and received in conformity with a second wireless communication standard more appropriate for ranging than the first wireless communication standard.

10. A system comprising:
a first communication device; and
a second communication device,
wherein the first communication device includes a first control unit that controls a process of transmitting a first ranging signal, receiving a second ranging signal transmitted as a response to the first ranging signal from the second communication device receiving the first ranging signal, and transmitting a data signal including information regarding a transmission time of the first ranging signal and a reception time of the second ranging signal,
wherein the second communication device includes a second control unit that controls a process of receiving the first ranging signal from the first communication device, transmitting the second ranging signal, and receiving the data signal from the first communication device,
wherein the data signal is transmitted and received in conformity with a first wireless communication standard, and
wherein the first and second ranging signals are transmitted and received in conformity with a second wireless communication standard more appropriate for ranging than the first wireless communication standard.
